(19) United States
(12) Patent Application Publication
(10) Pub. No.: US 2016/0188534 A1
(43) Pub. Date: Jun. 30, 2016

(54) COMPUTING SYSTEM WITH PARALLEL MECHANISM AND METHOD OF OPERATION THEREOF

(71) Applicant: Samsung Electronics Co., Ltd., Suwon-si (KR)

(72) Inventors: Tameesh Suri, San Jose, CA (US); Manu Awasthi, San Jose, CA (US); Mrinmoy Ghosh, San Jose, CA (US)

(21) Appl. No.: 14/674,399

(22) Filed: Mar. 31, 2015

Related U.S. Application Data
(60) Provisional application No. 62/098,508, filed on Dec. 31, 2014.

(51) Int. Cl. G06F 15/82; G06F 9/44; G06F 9/50

(52) U.S. Cl. CPC G06F 15/82; G06F 9/5011; G06F 9/4403

(57) ABSTRACT

A computing system includes: an identification block configured to determine a structural profile for representing a parallel structure of architectural components; and an arrangement block, coupled to the identification block, configured to generate memory sets based on the structural profile for representing the parallel structure.

### CROSS-REFERENCE TO RELATED APPLICATION(S)

This application claims the benefit of U.S. Provisional Patent Application Ser. No. 62/098,508 filed Dec. 31, 2014, and the subject matter thereof is incorporated herein by reference thereto.

### TECHNICAL FIELD

An embodiment of the present invention relates generally to a computing system, and more particularly to a system for parallel mechanism.

### BACKGROUND

Modern consumer and industrial electronics, such as computing systems, servers, appliances, televisions, cellular phones, automobiles, satellites, and combination devices, are providing increasing levels of functionality to support modern life. While the performance requirements can differ between consumer products and enterprise or commercial products, there is a common need for more performance while reducing power consumption. Research and development in the existing technologies can take a myriad of different directions.

One such direction includes improvements in storing and accessing information. As electronic devices become smaller, lighter, and require less power, the amount of faster memory can be limited. Efficiently or effectively using components or storage configurations can provide the increased levels of performance and functionality.

Thus, a need still remains for a computing system with parallel mechanism for improved processing performance while reducing power consumption through increased efficiency. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a system, including: an identification block configured to determine a structural profile for representing a parallel structure of architectural components; and an arrangement block, coupled to the identification block, configured to generate memory sets based on the structural profile for representing the parallel structure.

An embodiment of the present invention provides a method including: determining a structural profile for representing a parallel structure of architectural components; and generating memory sets with a control unit based on the structural profile for representing the parallel structure.

An embodiment of the present invention provides a non-transitory computer readable medium including instructions for: determining a structural profile for representing a parallel structure of architectural components; and generating memory sets based on the structural profile for representing the parallel structure.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is an exemplary block diagram of a computing system with parallel mechanism in an embodiment of the present invention.

FIG. 2 is a further detailed exemplary block diagram of the computing system.

FIG. 3 is a control flow of the computing system.

FIG. 4 is an example diagram of the firmware register in operation.

FIG. 5 is a flow chart of a method of operation of a computing system in an embodiment of the present invention.

### DETAILED DESCRIPTION

The following embodiments include memory sets configured according to parallel structure of architectural components for a memory unit. The memory sets can be configured for non-sequential or parallel access using qualified parallel sets during operation of operating system. The memory sets can further be dynamically reconfigured in response to an irregular status, based on determining a conflict source and generating adjusted sets based on the conflict source during run-time.

The memory sets can further be used to balance power consumption, processing capacity, or a combination thereof during run-time. Usable resource profile managing the memory sets can be generated to control the architectural components for balancing the consumption, the processing capacity, or a combination thereof.

The following embodiments are described in sufficient detail to enable those skilled in the art to make and use the invention. It is to be understood that other embodiments would be evident based on the present disclosure, and that system, process, architectural, or mechanical changes can be made without departing from the scope of an embodiment of the present invention.

In the following description, numerous specific details are given to provide a thorough understanding of the invention. However, it will be apparent that the invention and various embodiments may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, an embodiment can be operated in any orientation.

The term “block” referred to herein can include software, hardware, or a combination thereof in an embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof. Further, if a block is written in the apparatus claims section below, the blocks are deemed to include hardware circuitry for the purposes and the scope of apparatus claims.

The blocks in the following description of the embodiments can be coupled to one other as described or as shown. The coupling can be direct or indirect without or with, respectively, intervening between coupled items. The coupling can be physical contact or by communication between items.

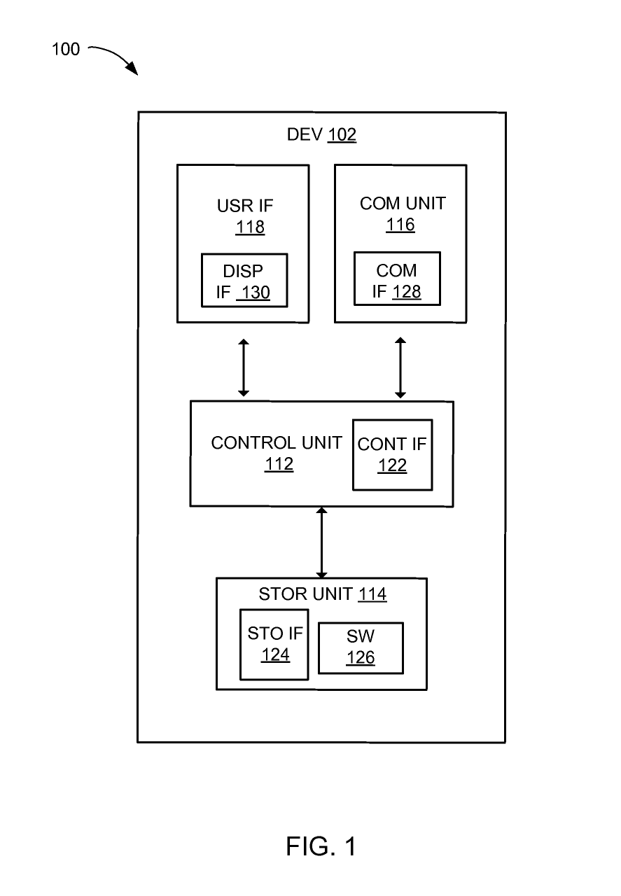

Referring now to FIG. 1, therein is shown an exemplary block diagram of a computing system 100 with parallel mechanism in an embodiment of the present invention. The computing system 100 can include a device 102. The device 102 can include a client device, a server, a display interface, a user interface device, a wearable device, an accelerator, a portal or a facilitating device, or combination thereof.

The device 102 can include a control unit 112, a storage unit 114, a communication unit 116, and a user interface 118. The control unit 112 can include a control interface 122. The control unit 112 can execute software 126 of the computing system 100.

In an embodiment, the control unit 112 provides the processing capability and functionality to the computing system 100. The control unit 112 can be implemented in a number of different manners. For example, the control unit 112 can be a processor or a portion therein, an application specific integrated circuit (ASIC) an embedded processor, a microprocessor, a central processing unit (CPU), a graphics processing unit (GPU), an FPGA, a hardware control logic, a hardware finite state machine (FSM), a digital signal processor (DSP), a hardware circuit with computing capability, or a combination thereof.

As a further example, various embodiments can be implemented on a single integrated circuit, with components on a daughter card or system board within a system casing, or distributed from system to system across various network topologies, or a combination thereof. Examples of network topologies include personal area network (PAN), local area network (LAN), storage area network (SAN), metropolitan area network (MAN), wide area network (WAN), or a combination thereof.

The control interface 122 can be used for communication between the control unit 112 and other functional units in the device 102. The control interface 122 can also be used for communication that is external to the device 102.

The control interface 122 can receive information from the other functional units or from external sources, or can transmit information to the other functional units or to external destinations. The external sources and the external destinations refer to sources and destinations external to the device 102.

The control interface 122 can be implemented in different ways and can include different implementations depending on which functional units or external units are being interfaced with the control interface 122. For example, the control interface 122 can be implemented with a pressure sensor, an inertial sensor, a microelectromechanical system (MEMS), optical circuitry, waveguides, wireless circuitry, wireline circuitry, or a combination thereof.

The storage unit 114 can store the software 126. The storage unit 114 can also store relevant information, such as data, images, programs, sound files, or a combination thereof. The storage unit 114 can be sized to provide additional storage capacity.

The storage unit 114 can be a volatile memory, a nonvolatile memory, an internal memory, an external memory, or a combination thereof. For example, the storage unit 114 can be a nonvolatile storage such as non-volatile random access memory (NVRAM), Flash memory, disk storage, or a volatile storage such as static random access memory (SRAM), dynamic random access memory (DRAM), any memory technology, or combination thereof.

The storage unit 114 can include a storage interface 124. The storage interface 124 can be used for communication with other functional units in the device 102. The storage interface 124 can also be used for communication that is external to the device 102.

The storage interface 124 can receive information from the other functional units or from external sources, or can transmit information to the other functional units or to external destinations. The external sources and the external destinations refer to sources and destinations external to the device 102.

The storage interface 124 can include different implementations depending on which functional units or external units are being interfaced with the storage unit 114. The storage interface 124 can be implemented with technologies and techniques similar to the implementation of the control interface 122.

For illustrative purposes, the storage unit 114 is shown as a single element, although it is understood that the storage unit 114 can be a distribution of storage elements. Also for illustrative purposes, the computing system 100 is shown with the storage unit 114 as a single hierarchy storage system, although it is understood that the computing system 100 can have the storage unit 114 in a different configuration. For example, the storage unit 114 can be formed with different storage technologies forming a memory hierarchal system including different levels of caching, main memory, rotating media, or off-line storage.

The communication unit 116 can enable external communication to and from the device 102. For example, the communication unit 116 can permit the device 102 to communicate with a second device (not shown), an attachment, such as a peripheral device, a communication path (not shown), or combination thereof.

The communication unit 116 can also function as a communication hub allowing the device 102 to function as part of a communication path and not limited to be an end point or terminal unit to the communication path. The communication unit 116 can include active and passive components, such as microelectronics or an antenna, for interaction with the communication path.

The communication unit 116 can include a communication interface 128. The communication interface 128 can be used for communication between the communication unit 116 and other functional units in the device 102. The communication interface 128 can receive information from the other functional units or can transmit information to the other functional units.

The communication interface 128 can include different implementations depending on which functional units are being interfaced with the communication unit 116. The communication interface 128 can be implemented with technologies and techniques similar to the implementation of the control interface 122, the storage interface 124, or combination thereof.

The user interface 118 allows a user (not shown) to interface and interact with the device 102. The user interface 118 can include an input device, an output device, or combination thereof. Examples of the input device of the user interface 118 can include a keypad, a touchpad, soft-keys, a keyboard, a microphone, an infrared sensor for receiving remote signals, other input devices, or any combination thereof to provide data and communication inputs.

The user interface 118 can include a display interface 130. The display interface 130 can include a display, a projector, a video screen, a speaker, or any combination thereof.

The control unit 112 can operate the user interface 118 to display information generated by the computing system 100. The control unit 112 can also execute the software 126 for the other functions of the computing system 100. The control unit 112 can further execute the software 126 for interaction with the communication path via the communication unit 116.

The device 102 can also be optimized for implementing an embodiment of the computing system 100 in a multiple device embodiment. The device 102 can provide additional or higher performance processing power.

For illustrative purposes, the device 102 is shown partitioned with the user interface 118, the storage unit 114, the control unit 112, and the communication unit 116, although it is understood that the device 102 can have any different partitioning. For example, the software 126 can be partitioned differently such that at least some function can be in the control unit 112 and the communication unit 116. Also, the device 102 can include other functional units not shown in for clarity.

The functional units in the device 102 can work individually and independently of the other functional units. For illustrative purposes, the computing system 100 is described by operation of the device 102 although it is understood that the device 102 can operate any of the processes and functions of the computing system 100.

Processes in this application can be hardware implementations, hardware circuitry, or hardware accelerators in the control unit 112. The processes can also be implemented within the device 102 but outside the control unit 112.

Processes in this application can be part of the software 126. These processes can also be stored in the storage unit 114. The control unit 112 can execute these processes for operating the computing system 100.

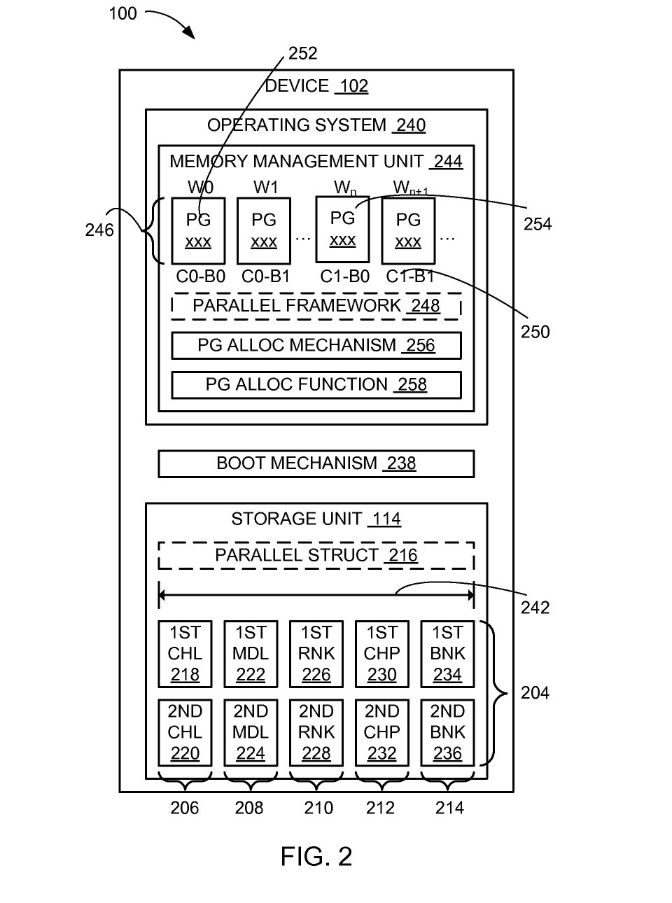

Referring now to FIG. 2, therein is shown a further detailed exemplary block diagram of the computing system 100. The storage unit 114 of the computing system 100 can include architectural components 204. The architectural components 204 can be a device or a portion therein for the storage unit 114.

The architectural components 204 can be arranged according to a parallel structure 216. The parallel structure 216 is an arrangement or a configuration of the architectural components 204 for parallel access or usage thereof. The parallel structure 216 can be based on simultaneously accessing multiple groupings or paths in accessing data. The parallel structure 216 can be based on availability of access, such as addressing or electrical connections, redundancy, relative electrical connections, or a combination thereof.

The parallel structure 216 can further be for simultaneously accessing data at multiple separate locations, independent locations, or a combination thereof. For example, the parallel structure 216 can be associated with multiple instances of cores, such as for the control unit 112 of FIG. 1, multiple separate instances of the storage unit 114, or a combination thereof. Also for example, the parallel structure 216 can be associated with parallelism of DRAM corresponding to the storage unit 114, such as for parallel architecture, access, or a combination thereof for the various components or within the DRAM.

For illustrative purposes, the parallel structure 216 is exemplified and discussed using DRAM. However, it is understood that the parallel structure 216 can be applicable to other parts or hierarchy, such as between units of FIG. 1, other memory architecture, such as other types of RAM or non-volatile memory, or a combination thereof.

The architectural components 204 can include circuitry for storing, erasing, managing, updating, or a combination thereof for information. For example, the architectural components 204 can include channels 206, modules 208, ranks 210, chips 212, banks 214, or a combination thereof. The channels 206 can include independently accessible structures or groupings within the storage unit 114. The channels 206 can each represent an independent access path or a separate access way, such as a wire or an electrical connection. The channels 206 can be the highest level structure.

The modules 208 can each be a circuitry configured to store and access information. The modules 208 can each be the circuitry within the storage unit 114 configured to store and access information. One or more sets of the modules 208 can be accessible through each of the channels 206.

The modules 208 can include RAM. For example, each of the modules 208 can include a printed circuit board or card with integrated circuitry mounted thereon. The storage unit 114 can include the channels 206, the modules 208, a component or a portion therein, or a combination thereof. For example, the modules 208 can include volatile or nonvolatile memory, NVRAM, SRAM, DRAM, Flash memory, a component or a portion therein, or a combination thereof.

The ranks 210 can be sub-units or grouping of information capacity of the modules 208. Each instance or occurrence of the modules 208 can include the ranks 210. The ranks 210 can include the sub-units or groupings sharing the same address, same data buses, a portion therein, or a combination thereof. One or more sets of the ranks 210 can be accessible within each of the modules 208 through corresponding instance of the channels 206.

The chips 212 can each be a unit of circuitry configured to store information therein. The chips 212 can each be the integrated circuitry in the modules 208. The chips 212 can be the component integrated circuits that make up each of the modules 208. Each instance of the modules 208, the ranks 210, or a combination thereof can include the chips 212.

Each of the ranks 210 can correspond to one or more of the chips 212, a portion within one of the chips 212, or a combination thereof. The ranks 210 can be selected using chip select in low level addressing. One or more sets of the chips 212 in the ranks 210 can be accessed through corresponding instance of the channels 206, the modules 208, or a combination thereof.

The banks 214 can be sub-units for data storage for the chips 212. Instances of the chips 212 can include the banks 214. Each of the banks 214 can be a portion within each of the chips 212 that is configured to store a unit of information. Each of the banks 214 can be a unit or a grouping of circuitry within each of the chips 212. One or more sets of the banks 214 in the chips 212 can be accessed through corresponding instance of the channels 206, the modules 208, the ranks 210, or a combination thereof.

For example, the architectural components 204 can be arranged according to the channels 206. The channels 206 can be for accessing independent or overlapping sets of the modules 208. Each of the modules 208 can include the ranks 210. Each of the ranks 210 can correspond to the chips 212. Each of the chips 212 can include banks 214.

Also for example, the parallel structure 216 can be for multiple instances of the channels 206, the modules 208, the ranks 210, the chips 212, the banks 214, or a combination thereof. As a more specific example, the parallel structure 216 can be for the channels 206 including a first channel component 218 and a second channel component 220, for the modules 208 including a first module component 222 and a second module component 224, for the ranks 210 including a first rank component 226 and a second rank component 228, for the chips 212 including a first chip component 230 and the second chip component 232, for the banks 214 including a first bank component 234 and a second bank component 236.

The first channel component 218 and the second channel component 220 can each be one of the channels 206. The first channel component 218 and the second channel component 220 can be separate, independent, or a combination thereof relative to each other. The first channel component 218 and the second channel component 220 can be accessed simultaneously or independent of each other for the parallel structure 216 in accessing information.

Similarly, the first module component 222 and the second module component 224 can each be one of the modules 208 that are separate, independent, or a combination thereof relative to each other, and accessible simultaneously or independent of each other for the parallel structure 216. Similarly, the first rank component 226 and the second rank component 228 can each be one of the ranks 210 that are separate, independent, or a combination thereof relative to each other, and accessible simultaneously or independent of each other for the parallel structure 216.

Similarly, the first chip component 230 and the second chip component 232 can each be one of the chips 212 that are separate, independent, or a combination thereof relative to each other, and accessible simultaneously or independent of each other for the parallel structure 216. Similarly, the first bank component 234 and the second bank component 236 can each be one of the banks 214 that are separate, independent, or a combination thereof relative to each other, and accessible simultaneously or independent of each other for the parallel structure 216.

For illustrative purposes, the computing system 100 is described above as utilizing the architectural components 204 with specific components or hierarchy as described above. However, it is understood that the architectural components 204 can include other components or hierarchies. For example, the bank 214 can include a lower level of circuitry. Also for example, the storage unit 114 can include different groupings for the devices or circuits.

The computing system 100 can include a booting mechanism 238. The booting mechanism 238 is a process, a method, a circuitry for implementing the process or the method, or a combination thereof for initializing the computing system 100. The booting mechanism 238 can be for initializing the computing system 100 after power is initially supplied to the computing system 100 or after the computing system 100 is reset, such as through a hardware input or a software command.

The booting mechanism 238 can include a Basic Input/Output System (BIOS) implemented in firmware. The booting mechanism 238 can reside in the storage unit 114, the control unit 112, a separate reserved storage area, or a combination thereof. As a more specific example, the booting mechanism 238 can reside in electrically erasable and programmable read only memory (EEPROM) or flash-memory on a motherboard. The control unit 112, the storage unit 114, the separate reserved storage area, or a combination thereof can access and implement the booting mechanism 238 for initializing the computing system 100.

The computing system 100 can further include an operating system 240. The operating system 240 can include a method or a process for managing operating of the computing system 100. The operating system 240 can include the software 126 of FIG. 1. The operating system 240 can also be a part of the software 126 for the computing system 100. The operating system 240 can manage the hardware, such as the units shown in FIG. 1, other application software, such as for the software 126, or a combination thereof.

The computing system 100 can include a granularity level 242 for the storage unit 114. The granularity level 242 is a representation of an available degree of control over the storage unit 114. The granularity level 242 can include a representation of accessibility to the architectural components 204 of the storage unit 114 available or visible for the control unit 112, the operating system 240, the booting mechanism 238, or a combination thereof. For example, the granularity level 242 can correspond to one or more levels in a hierarchy in the architectural components 204.

The operating system 240 can include a memory management unit (MMU) 244 or an access thereto. The memory management unit 244 is a device, a process, a method, a portion thereof, or a combination thereof for controlling access to information. The memory management unit 244 can be implemented with a hardware device or circuitry, a software function, firmware, or a combination thereof. The memory management unit 244 can manage or control access based on processing addresses.

For example, the memory management unit 244 can translate between virtual memory addresses and physical addresses. The virtual memory address can be an identification of a location of instruction or data for the operating system 240. The virtual memory address can be the identification of a location within the software 126 or a set of instructions used by the operating system 240. The virtual memory address can be made available for a process. The virtual memory can be mapped or tied to a physical address.

The physical address can be an identification of a location in the storage unit 114. The physical address can represent a circuitry or a portion within physical memory or a memory device. The physical address can be used to access the data or information stored in the particular corresponding location of the storage unit 114. The physical address can describe or represent specific instances of the channels 206, the modules 208, the ranks 210, the chips 212, the banks 214, or a combination thereof for the particular corresponding location or the data stored therein.

The memory management unit 244 can include memory sets 246. The memory sets 246 can each include a continuous grouping of memory. The memory sets 246 can each include a fixed-length or a unit length of storage grouping for the virtual memory. The memory sets 246 can be the smallest unit or grouping for the virtual memory. For example, each of the memory sets 246 can be a memory page corresponding to a single entry in a page table.

The memory sets 246 can be units of data for memory allocation performed by the operating system on behalf of a program. The memory sets 246 can be for transferring between main memory and other auxiliary stores, such as a hard disk or external storage.

The memory management unit 244 can include a parallel framework 248. The parallel framework 248 is a method, a process, a device, a circuitry, or a combination thereof for arranging or structuring the memory sets 246. The parallel framework 248 can be implemented during operation of the operating system 240, the booting mechanism 238, or a combination thereof. The parallel framework 248 can implement an architecture, a characteristic, a configuration, or a combination thereof of the memory sets 246. The memory management unit 244 can arrange or configure the memory sets 246 with the parallel framework 248.

The parallel framework 248 for the memory management unit 244 can arrange or configure the memory sets 246 to reflect the parallel structure 216 of the architectural components 204. The parallel framework 248 can arrange or configure the memory sets 246 according to the parallel structure 216 of the architectural components 204. The parallel framework 248 can arrange or configure the memory sets 246 to mirror the parallel structure 216 of the architectural components 204.

The parallel framework 248 can arrange or configure the memory sets 246 by dividing a resource, arranging resources, identifying a resource, or a combination thereof for the memory sets 246. The memory management unit 244 can divide, arrange, identify, or a combination thereof with the memory sets 246 such that instances of the memory sets 246 corresponding to the architectural components 204 can be accessed or utilized simultaneously, separately, independently of each other, or a combination thereof.

The parallel framework 248 can further generate a structure-reflective organization 250 for the memory sets 246. The structure-reflective organization 250 is a distinction for each instance of the memory sets 246 or relationships between each instances of the memory sets 246 for the parallel framework 248. The structure-reflective organization 250 can include identification, address, specific path, arrangement, mapping to components, or a combination thereof for each of the memory sets 246.

For example, the parallel framework 248 can generate, configure, arrange, or a combination thereof for a first page 252 and a second page 254 for representing or matching the architectural components 204 including the parallel structure 216. The first page 252 and the second page 254 can each be an instance or an occurrence of the memory sets 246. The parallel framework 248 can allocate or divide resources, configure access thereto, identify or connect thereto, or a combination thereof to generate, configure, arrange, or a combination thereof for the first page 252 and the second page 254.

Continuing with the example, the parallel framework 248 can identify, divide, configure, utilize, or a combination thereof for instances of the memory sets 246, allowing independent or separate access or utilization to generate the first page 252 and the second page 254. The parallel framework 248 can further identify the parallel structure 216, the finest instance of the granularity level 242 accessible to the operating system 240, or a combination thereof.

Continuing with the example, the parallel framework 248 can generate a relationship, a correspondence, a mapping, a representation, a reflection or a combination thereof between the memory sets 246 with independent or separate accessibility and the architectural components 204 associated with the parallel structure 216, the finest instance of the granularity level 242 allowing for the parallel structure 216, or a combination thereof. As a more specific example, the first page 252 can be tied to the first channel component 218, the first module component 222, the first rank component 226, the first chip component 230, the first bank component 234, or a combination thereof. The second page 254 can similarly be tied to the second channel component 220, the second module component 224, the second rank component 228, the second chip component 232, the second bank component 236, or a combination thereof.

Continuing with the example, the parallel framework 248 can generate the connection based on generating the structure-reflective organization 250, arranging entries in the page table, or a combination thereof. The first page 252 and the second page 254 can each include the structure-reflective organization 250 for accessing the first page 252 and the second page 254. The structure-reflective organization 250 for the first page 252 and the second page 254 can allow access to or utilization of the first page 252 and the second page 254 simultaneously, separately, independently of each other, or a combination thereof.

The memory management unit 244 can further include a set qualification mechanism 256, a set allocation function 258, or a combination thereof. The set qualification mechanism 256 is a method, a process, a device, a circuitry, or a combination thereof for determining the memory sets 246 satisfying a condition.

For example, the set qualification mechanism 256 can be for determining the memory sets 246 available for access or processing, causing an error or a failure, going below or above a threshold, or a combination thereof. As a more specific example, the set qualification mechanism 256 can be for identifying readiness or accessibility for the memory sets 246. The set qualification mechanism 256 can identify free or unused instances of the memory sets 246 available for access or processing.

Continuing with the example, the set qualification mechanism 256 can identify the availability of the memory sets 246 during run-time, operation, execution, or a combination thereof for the device 102. The set qualification mechanism 256 can include various implementations, such as a weighted round robin policy, a least recently used (LRU) policy, a most frequently or often used policy, or a combination thereof.

The set allocation function 258 is a method, a process, a device, a circuitry, or a combination thereof for selecting one or more instances of the memory sets 246 for access. The set allocation function 258 can select the one or more instances of the memory sets 246 from a result of the set qualification mechanism 256. For example, the set allocation function 258 can include an equation, a scheme, or a combination thereof. As a more specific example, the set allocation function 258 can include a minimum function or a routine based on identification of a pattern.

The computing system 100 can implement the various mechanisms described above in various ways. For example, the computing system 100 can implement the booting mechanism 238, the set qualification mechanism 256, or a combination thereof using hardware, software, firmware, or a combination thereof. As a more specific example, the various mechanisms can be implemented using circuits, active or passive, gates, arrays, feedback loops, feed-forward loops, hardware connections, functions or function calls, instructions, equations, data manipulations, structures, addresses, or a combination thereof.

It has been discovered that the parallel framework 248, configuring or arranging the memory sets 246 to mirror and represent the parallel structure 216 of the architectural components 204 provides efficient usage of the architectural components 204. The memory sets 246 mirroring and representing the parallel structure 216 of the architectural components 204 can be used to evenly distribute application memory across the architectural components 204.

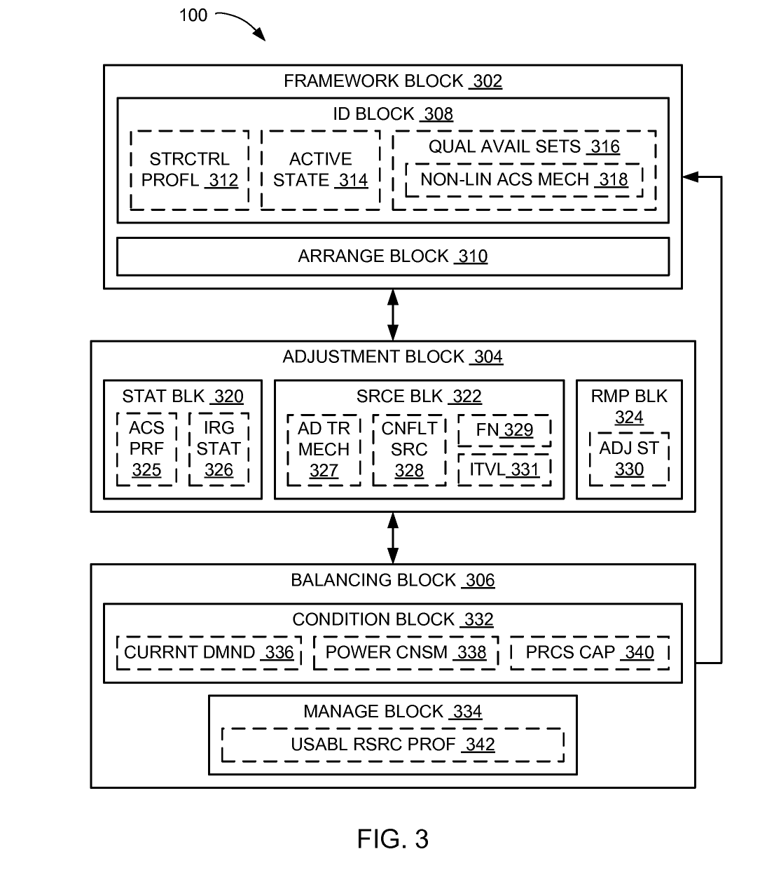

Referring now to FIG. 3, therein is shown a control flow of the computing system 100. The computing system 100 can include a framework block 302, an adjustment block 304, a balancing block 306, or a combination thereof.

The framework block 302 can be coupled to the adjustment block 304. The adjustment block 304 can be further coupled to the balancing block 306.

The blocks, buffers, units, or a combination thereof can be coupled to each other in a variety of ways. For example, blocks can be coupled by having the input of one block connected to the output of another, such as by using wired or wireless connections, instructional steps, process sequence, or a combination thereof. Also for example, the blocks, buffers, units, or a combination thereof can be coupled either directly with no intervening structure other than connection means between the directly coupled blocks, buffers, units, or a combination thereof, or indirectly with blocks, buffers, units, or a combination thereof other than the connection means between the indirectly coupled blocks, buffers, units, or a combination thereof.

As a more specific example, one or more inputs or outputs of the framework block 302 can be connected to one or more inputs or outputs of the adjustment block 304 using conductors or operational connections there-between for direct coupling. Also for example, the framework block 302 can be coupled to the adjustment block 304 indirectly through other units, blocks, buffers, devices, or a combination thereof. The blocks, buffers, units, or a combination thereof for the computing system 100 can be coupled in similar ways as described above.

The framework block 302 is configured to manage the memory sets 246 of FIG. 2. The framework block 302 can manage by generating a resource, configuring a resource, arranging a resource, or a combination thereof for the memory sets 246. The framework block 302 can include an identification block 308, an arrangement block 310, or a combination thereof.

The identification block 308 is configured to identify configuration, availability, or a combination thereof for the hardware resources. The identification block 308 can identify the architectural components 204 of FIG. 3, the parallel structure 216 of FIG. 2, the granularity level 242 of FIG. 2, or a combination thereof. The identification block 308 can determine a structural profile 312 for representing the parallel structure 216 of the architectural components 204 in the storage unit 114 of FIG. 1.

The structural profile 312 is a representation of the architectural components 204 and the configuration thereof. The structural profile 312 can include a description of the architectural components 204, arrangements or relationships between the architectural components 204, or a combination thereof. The structural profile 312 can describe or represent the parallel structure 216 for the architectural components through describing or representing the arrangements or the relationships of the components.

The identification block 308 can determine the structural profile 312 based on the granularity level 242 accessible to the identification block 308. The identification block 308 can interact with the booting mechanism 238 of FIG. 2. The identification block 308 can determine the granularity level 242 for visibility or access for the architectural components 204 of the storage unit 114 through the booting mechanism 238.

For example, the BIOS can include the method or the process for recognizing, controlling, or accessing individual instances of the channels 206 of FIG. 2, the modules 208 of FIG. 2, the ranks 210 of FIG. 2, the chips 212 of FIG. 2, the banks 214 of FIG. 2, or a combination thereof. The operating system 240 of FIG. 2 can effectively access and control the architectural components 204 at the granularity level 242 determined by the identification block 308, designated by the booting mechanism 238, or a combination thereof.

Also for example, the identification block 308 can determine the granularity level 242 based on identifications, such as a categorization of a device or a part number for the architectural components 204 or the storage unit 114, available drivers for the devices or components, or a combination thereof. The identification block 308 can include mappings, descriptions, values, or a combination thereof predetermined by the computing system 100 relating the granularity level 242 to specific instances of the architectural components 204 or the storage unit 114, the available drivers for the devices or components, or a combination thereof.

The identification block 308 can further determine the structural profile 312 based on the identification of the architectural components 204 or the storage unit 114, available drivers for the devices or components, or a combination thereof. The identification block 308 can communicate with the storage unit 114 or the architectural components 204 therein using the control interface 122 of FIG. 1, the storage interface 124 of FIG. 1, or a combination thereof. The identification block 308 can identify the identification during execution of, or through, the booting mechanism 238.

The identification block 308 can determine the structural profile 312 based on communicating with the storage unit 114 or the architectural components 204 therein. For example, the identification block 308 can determine the structural profile 312 based on identifying individual components responding to a query.

Also for example, the identification block 308 can determine the structural profile 312 based on identification information or descriptions provided by the storage unit 114. The identification block 308 can further include descriptions or representations predetermined by the computing system 100 relating various possible instances or values for the structural profile 312 with a list of possible device descriptions or identifications.

The identification block 308 can further access and identify the memory sets 246 during an active state 314. The active state 314 can represent a real-time execution of the operating system 240, or the device 102 of FIG. 1. The active state 314 can be subsequent to the initialization of the device 102 using the booting mechanism 238.

The identification block 308 can generate qualified available sets 316 according to non-linear access mechanism 318 for representing the memory sets 246 reflecting the parallel structure 216 during the active state 314. The qualified available sets 316 are instances of the memory sets 246 available for use or access in the active state 314. The qualified available sets 316 can include an addresses, a physical memory location, a memory page, or a combination thereof available for read, write, free or delete, move, or a combination of operations thereof.

The identification block 308 can generate the qualified available sets 316 based on the set qualification mechanism 256 of FIG. 2. For example, the identification block 308 can generate the qualified available sets 316 based on a weighted round robin policy, an LRU policy, a most frequently or often used policy, or a combination thereof as designated for the set qualification mechanism 256.

The identification block 308 can generate the qualified available sets 316 according to the non-linear access mechanism 318. The non-linear access mechanism 318 is a structure or an organization of the qualified available sets 316 reflecting the parallel structure 216 of the architectural components 204. The non-linear access mechanism 318 can include a separate listing or availability for each of the qualifying instances of the memory sets 246. The non-linear access mechanism 318 can list or avail each of the qualifying instances of the memory sets 246 for simultaneous or non-sequential independent access.

For example, each page list including the memory sets 246, organized by DRAM bank, can be associated with a weight, representing list occupancy by the identification block 308 for the non-linear access mechanism 318. Each page request during the active state 314 can result in selecting pages from a list with lowest value or amount of weights for the qualified available sets 316. The identification block 308 can utilize local DRAM pages first, with optional constraints defined by the computing system 100, a user, an application, or a combination thereof. The identification block 308 can generate the qualified available sets 316 based on organizing the free page list on the basis of maximum-available DRAM bank-level parallelism.

It has been discovered that the qualified available sets 316 including the non-linear access mechanism 318 based on the parallel structure 216 provides increased speed and efficiency for the computing system 100. The qualified available sets 316 based on the parallel structure 216 can reflect the parallel structure 216 of the architectural components 204 in the listing of available or free pages, instead of a traditional linear listing. The qualified available sets 316 can provide multiple listings of free or available pages each for parallel components, and split the pages across the parallel structure 216. The non-linear access mechanism 318 can enable the computing system 100 to utilize maximum available parallelism, and evenly utilize free pages across all banks for increasing efficiency and access speed.

The arrangement block 310 is configured to generate, maintain, or adjust the memory sets 246. The arrangement block 310 can implement the memory sets 246 for mirroring the parallel structure 216. The arrangement block 310 can generate the memory sets 246 based on the structural profile 312 for representing the parallel structure 216.

The arrangement block 310 can generate the memory sets 246 with the structure-reflective organization 250 of FIG. 2 mirroring the parallel structure 216. The arrangement block 310 can generate the memory sets 246 according to memory address maps mirroring the parallel structure 216. The arrangement block 310 can generate the memory sets 246 based on the structural profile 312 at system boot time using, or through, the booting mechanism 238.

For example, the arrangement block 310 can generate the memory sets 246 including the first page 252 of FIG. 2 and the second page 254 of FIG. 2 with the structure-reflective organization 250. The arrangement block 310 can generate the first page 252 corresponding or matching the first channel component 218 of FIG. 2, the first module component 222 of FIG. 2, the first rank component 226 of FIG. 2, the first chip component 230 of FIG. 2, the first bank component 234 of FIG. 2, or a combination thereof. The arrangement block 310 can further generate the second page 254 corresponding or matching the second channel component 220 of FIG. 2, the second module component 224 of FIG. 2, the second rank component 228 of FIG. 2, the second chip component 232 of FIG. 2, the second bank component 236 of FIG. 2, or a combination thereof.

The arrangement block 310 can generate the memory sets 246 according to the structure-reflective organization 250 in a variety of ways. For example, the arrangement block 310 can generate the memory sets 246 including a size or an accessibility matching the corresponding instance of the architectural components, the hierarchy thereof, the parallel structure 216 thereof, or a combination thereof.

Also for example, the arrangement block 310 can generate the memory sets 246 corresponding to the lowest instance of the granularity level 242. As a more specific example, the arrangement block 310 can generate the first page 252 and the second page 254 matching the first bank component 234 and the second bank component 236, respectively, for the granularity level 242 representing visibility or control down to the banks 214.

The arrangement block 310 can generate the memory sets 246 matching the grouping, hierarchy, sequence, relative location or relationship, or a combination thereof associated with the architectural components 204. Continuing with the example, the first page 252 and the second page 254 can be assigned identifications corresponding to the hierarchy associated with the corresponding components, such as ‘C0-B0’ for ‘chip 0-bank 0’ or ‘C0-B1’ for ‘chip 0-bank 1’ as illustrated in FIG. 2.

As a different example, the first page 252 and the second page 254 can be immediately adjacent to each other when they correspond to adjacently addressed instances of the banks 214 for the same instance of the chips 212. Also as a different example, the first page 252 and the second page 254 can be located differently or relatively further apart when they correspond to non-adjacently addressed instances of the banks 214 for the same chip or corresponding to the banks 214 of different chips.

The arrangement block 310 can further dynamically adjust the memory sets 246 during the active state 314 of the operating system 240. The arrangement block 310 can adjust based on selecting one or more instances of the memory sets 246 for access or usage during the active state 314. The arrangement block 310 can adjust the memory sets 246 by updating or allowing adjustments to the memory sets 246 or content therein through read, write, free or delete, move, or a combination of operations thereof.

The arrangement block 310 can determine one or more instances of the memory sets 246 from within the qualified available sets 316 for read, write, free or delete, move, or a combination of operations thereof. The arrangement block 310 can determine the one or more instances of the memory sets 246 using the set allocation function 258 of FIG. 2. The operating system 240 can perform the read, write, free or delete, move, or a combination of operations thereof using the one or more instances of the memory sets 246 dynamically determined by the arrangement block 310 during the active state 314.

It has been discovered that the memory sets 246 mirroring and representing the parallel structure 216 of the architectural components 204 provides efficient usage of the architectural components 204. The memory sets 246 mirroring and representing the parallel structure 216 of the architectural components 204 can be used to evenly distribute application memory across the architectural components 204.

The framework block 302 can use the parallel framework 248 of FIG. 2, the memory management unit 244 of FIG. 2, the booting mechanism 238, or a combination thereof to manage the memory sets 246 as described above. The framework block 302 can further use the control unit 112, the control interface 122, the storage unit 114, the storage interface 124, or a combination thereof. The framework block 302 can store the processing result, such as the memory sets 246 reflecting the parallel structure 216, the structural profile 312, the qualified available sets 316, or a combination thereof in the control unit 112, the storage unit 114, or a combination thereof.

After managing the memory sets 246, the control flow can pass to the adjustment block 304. The control flow can pass through a variety of ways. For example, control flow can pass by having processing results of one block passed to another block, such as by passing the processing result from the framework block 302 to the adjustment block 304.

Also for example, the control flow can pass by storing the processing results at a location known and accessible to the other block, such as by storing the memory sets 246 or the page list, at a storage location known and accessible to the adjustment block 304. Also for example, the control flow can pass by notifying the other block, such as by using a flag, an interrupt, a status signal, or a combination thereof.

The adjustment block 304 is configured to correct the memory sets 246 or content therein. The adjustment block 304 can correct for the memory sets 246 during or in the active state 314 of the operating system 240. The adjustment block 304 can include a status block 320, a source block 322, a remapping block 324, or a combination thereof for correcting the memory sets 246 or the content therein.

The status block 320 is configured to detect anomalies associated with the memory sets 246. The status block 320 can implement a dynamic application profiling mechanism to identify specific pages applications use that contends for same DRAM resources.

The status block 320 can provide continuous system monitoring with minimal overhead to detect DRAM resource contention. The status block 320 can use the parallel framework 248 to profile activity at various granularities to understand the application and DRAM resource utilizations. To profile activity at various granularities, the status block 320 can sample hardware performance counters identified by the control unit 112, provided by processor vendors, predetermined by the computing system 100, or a combination thereof.

The status block 320 can detect anomalies based on detecting an irregular status 326. The status block 320 can detect the irregular status 326 during the active state 314.

The irregular status 326 is a processing result or condition associated with accessing one or more of the memory sets 246. The irregular status 326 can include a processing result or a condition, such as an error, a failure, a timeout, a processing duration, an access conflict, or a combination thereof. The status block 320 can identify the irregular status 326 for the memory sets 246 reflecting the parallel structure 216 as generated and managed by the framework module 208 described above.

The status block 320 can provide continuous system monitoring for the irregular status 326, such as resource conflicts and cache misses. The status block 320 can further monitor based on profiling the activity associated with the memory sets 246 for various categories.

For example, the status block 320 can generate an access profile 325 describing the activity associated with the memory sets 246. As a more specific example, the status block 320 can generate the access profile 325 for utilization of the architectural components 204. The categorization can include channel utilization, rank utilization, bank utilization, or a combination thereof.

The status block 320 can further update the access profile 325 by recording precharges issued per bank, such as due to page conflicts, to maintain page miss rates. The precharges can be issued due to page conflicts. The status block 320 can update the access profile 325 during the active state 314 to maintain page miss rates.

The status block 320 can determine the irregular status 326 based on the access profile 325. The status block 320 can determine the irregular status 326 based on the number or amount of precharges, misses, or conflicts. The status block 320 can determine the irregular status 326 based on comparing the records in the access profile 325 against a threshold predetermined by the computing system 100 or an adaptive self-learning threshold designated by the computing system 100. The status block 320 can determine the irregular status 326 based on identifying applications with high memory traffic by monitoring last level cache miss rates.

The status block 320 can collect and process data over a moving window or individually. On detecting resource contention, the status block 320 can use the parallel framework 248 to identify the core, the application, the resource, such as for the architectural components 204, or a combination thereof.

The status block 320 can further process the records for the access profile 325 in determining the irregular status 326. For example, the status block 320 can apply weights or factors corresponding to the utilization, a frequency or a duration associated with utilization or conflict, a contextual value or priority associated with processes or threads associated with utilization or running at the moment of conflict, or a combination thereof. The status block 320 can include instructions, equations, methods, or a combination thereof predetermined by the computing system 100 for processing the access profile 325 and determining the irregular status 326.

It has been discovered that the access profile 325 provides lower error rates and decreased latency for the computing system 100. The access profile 325 categorizing and recording utilization, and further recording precharges representing page conflicts can provide information useful to determine the causes of resource conflicts. For example, the access profile 325 can be used to determine the application or thread responsible for most DRAM resource conflicts. Moreover, the access profile 325 implemented by the status block 320 can provide a less intrusive and lighter-weight mechanism for gathering usage and conflict data.

The source block 322 is configured to determine a source or a cause for resource conflicts. The source block 322 can identify a page, an address, or a combination thereof responsible for or causing the resource conflicts. The source block 322 can determine the source or the cause based on, or in response to, determination of the irregular status 326. The source block 322 can identify the OS pages causing the resource contention.

The source block 322 can identify one or more pages of the operating system 240, such as the first page 252 or the second page 254, causing the resource contention. The source block 322 can identify the cause of the resource contention based on dynamically injecting, instrumenting, or a combination thereof for the application with special instructions to intercept load or store addresses. The source block 322 can further identify the cause without utilizing virtual machines.

The source block 322 can identify the cause based on an address tracing mechanism 327. The address tracing mechanism 327 is a method, a process, a device, a circuitry, or a combination thereof for identifying physical addresses for the operating system 240. For example, the operating system 240 can use the address tracing mechanism 327 to gain insight into the physical addresses at the DRAM/memory controller cluster. The operating system 240 can otherwise be without any visibility or access to the physical addresses.

The address tracing mechanism 327 can gain insight based on dynamically injecting, instrumenting, or a combination thereof for the application with special instructions. The special instructions can allow the operating system 240 to intercept physical addresses associated with load or store functions.

The address tracing mechanism 327 can include a trap function 329, or a use thereof. The trap function 329 is one or more unique instructions for intercepting, identifying, determining, or a combination thereof a physical addresses accessed during the active state 314.

The trap function 329 can parse through an instruction stream associated with the operating system 240, a program or an application, or a combination thereof. The trap function 329 can identify an address associated with a load instruction, a store instruction, or a combination thereof in the instruction stream.

The trap function 329 can further store the load instruction, the store instruction, a physical address associated thereto, or a combination thereof. The trap function 329, as an example, can store using a temporary tracing profile. On loops, the trap function 329 can save the first and last iteration of the arrays, keeping overhead for the virtual address tracing minimal.

The address tracing mechanism 327 can further include an injection interval 331. The injection interval 331 is a representation or a metric for a regular interval for injecting the trap function 329 into the instruction stream. The injection interval 331 can be a duration of time, a number of clock cycles, a quantity of instructions, a specific instruction or process, or a combination thereof. The source block 322 can use the address tracing mechanism 327 to inject the instruction stream with one or more instances of the trap function 329 at regular intervals according to the injection interval 331.

The source block 322 can use the address tracing mechanism 327 to identify a conflict source 328. The conflict source 328 is a portion within the memory sets 246 causing resource conflict. The conflict source 328 can include a page for the operating system 240, a physical address, a specific instance of the architectural components 204, or a combination thereof associated with or causing the irregular status 326.

The source block 322 can identify the conflict source 328 in one or more of the memory sets 246 associated with the irregular status 326 during the active state 314. The source block 322 can identify the conflict source 328 based on the output of the trap function 329, such as in the temporary tracing profile. The source block 322 can identify the conflict source 328 based on the page, the physical address, the specific instance of the architectural components 204, or a combination thereof from the trap function 329.

The source block 322 can further identify the conflict source 328 based on the access profile 325, such as the precharges, record or evidence of resource conflicts or errors, or a combination thereof. For example, the remapping block 324 can derive pages for the operating system 240 from the virtual addresses. As a more specific example, the source block 322 can identify the conflict source 328 as the page, the physical address, the specific instance of the architectural components 204, or a combination thereof corresponding to the precharges, records or evidence of resource conflicts or errors, or a combination thereof.

The source block 322 can further identify the conflict source 328 based on identifying the virtual addresses captured by the trap function 329 corresponding to the physical pages. The source block 322 can identify the virtual addresses associated with the physical pages based on one or more APIs provided by the operating system 240. The source block 322 can profile as described above for specific cores with high last level cache misses to reduce the instrumentation overhead.

Since the page identification phase of the source block 322 can be more resource intensive than the conflict identification phase of the status block 320, the computing system 100 can continue to monitor conflicts with the status block 320 during the page identification phase of the source block 322. If the number of conflicts is below some pre-defined threshold during the conflict identification phase of the status block 320, the computing system 100 can transition to the default conflict identification phase of the status block 320.

The remapping block 324 is configured to eliminate or minimize the resource conflict. The remapping block 324 can process the conflict source 328 to eliminate or minimize the resource conflict. The remapping block 324 can process the conflict source 328 by correcting, remapping, adjusting, or a combination thereof for the page, the address, the component, or a combination thereof. The remapping block 324 can provide or utilize heuristics that estimate physical page migration cost and its performance effect.

The remapping block 324 can process the conflict source 328 by generating adjusted sets 330. The adjusted sets 330 are adjusted or corrected instances of the memory sets 246. The adjusted sets 330 can include the adjustment or correction for the conflict source 328.

The remapping block 324 can generate the adjusted sets 330 based on calculating a processing gain associated with processing the conflict source 328. The remapping block 324 can calculate the processing gain in comparison to a processing cost associated with processing the conflict source 328. The remapping block 324 can calculate and compare the processing gain to the processing cost for generating the adjusted sets 330.

The remapping block 324 can trigger adjustment for the memory sets 246 or generating of the adjusted sets 330 based on the calculation and comparison of the processing gain and the processing cost. For example, the remapping block 324 can generate the adjusted sets 330 according to a heuristic mechanism, represented as:

α·C+β·P<τ(D*B). Equation (1).

The remapping block 324 can calculate the gain, the cost, the trigger, or a combination thereof based on various factors.

Factors can include a time to service a cache miss, represented as ‘α’, a time to service a translation lookaside buffer (TLB), represented as ‘β’, threshold or number of predicted iterations, represented as ‘τ’, or a combination thereof. Factors can further include a number of cache misses, represented as ‘C’, a number of page migrations, represented as ‘P’, DRAM conflicts, represented as ‘D’, time to service bank conflicts, represented as ‘B’, or a combination thereof.

The remapping block 324 can utilize various times and thresholds, such as for ‘α’, ‘β’, ‘τ’, ‘B’, or a combination thereof predetermined by the computing system 100, specific to the architectural components 204, reported by the storage unit 114 or the control unit 112, observed by the control unit 112 during the active state 314, or a combination thereof. The remapping block 324 can calculate or access and utilize various numbers or predictions, such as for ‘τ’, ‘C’, ‘P’, ‘D’, or a combination thereof.

The various numbers can be predetermined, reported, observed, or a combination thereof similar to the various times and thresholds. The various numbers can further be determined or calculated during the active state 314, such as included in the access profile 325.

The remapping block 324 can generate the adjusted sets 330 by adjusting the memory sets 246 when the calculated gain, represented on the right side of the Equation (1), is greater than the cost, represented on the left side of the evaluation in Equation (1), for example. The remapping block 324 can adjust the memory sets 246 based on removing, correcting, remapping, or a combination thereof for the conflict source 328 to generate the adjusted sets 330 in response to the irregular status 326.

The remapping block 324 can perform removal, correction, remapping, or a combination of operations thereof for the page, the address, the component, or a combination thereof from the memory sets 246 to generate the adjusted sets 330 for replacing the memory sets 246 or a portion therein associated with the conflict source 328. For example, the remapping block 324 can generate the adjusted sets 330 based on performing a page migration, including shooting down entries in the TLB for the old page mapping in the target CPUs and resulting in cold cache misses, for the memory sets 246.

The remapping block 324 can generate the adjusted sets 330 dynamically, such as during operation of the operating system 240 or for the active state 314 without resetting the computing system 100 or reinitiating the booting mechanism 238. The remapping block 324 can generate the adjusted sets 330 in response to the irregular status 326 or when the status block 320 determines the irregular status 326 during operation of the operating system 240 or for the active state 314.

The remapping block 324 can utilize the heuristic mechanism exemplified in Equation (1) in a moving window or individually per sample. The heuristic mechanism can represent that, based on previous history, τ number of iteration can be predicted in the future. Each of the iterations can result in a number of DRAM bank conflicts, resulting in execution time overhead. The time to service a miss in DRAM can be described as: tRP+tRCD+tCL. The heuristic mechanism can compare the execution overhead with the time to migrate pages, which requires TLB page walks and cache warmup time. Either constant timing values can be used for TLB and servicing cache misses, or the operating system 240 can profile the CPU at boot time for such information. New pages can be selected from the parallel framework using various selecting mechanism, such as least utilization or longest time to last access, such as may be available through profiling.

It has been discovered that the adjusted sets 330 generated dynamically provides decreased error rates and increased efficiency. The dynamic generation of the adjusted sets 330 during the active state 314 without resetting the system or reinitiating the booting mechanism 238 can seamlessly correct sources of errors or conflicts without interrupting ongoing processes for the computing system 100. Further, the adjusted sets 330 can be dynamically generated when the gain exceeds the cost, thereby preserving the net gain of the correction.

The dynamically generated adjusted sets 330 can include implementation of runtime page allocation of the operating system 240. The dynamic generation of the adjusted sets 330 can provide optimization through eliminating or reducing DRAM resource contention since one-time, static page allocation does not consider application's runtime behavior or interactions with other system processes.

It has further been discovered that the trap function 329 provides ability to correct errors or conflicts for the operating system 240 while minimizing processing overhead cost. The trap function 329 parsing through the instruction stream and identifying load and store instructions provides insight for the operating system 240 into the physical addresses at the DRAM/memory controller cluster, enabling corrections and adjustments described above. Further, the trap function 329 can minimize the overhead cost based on the simplicity thereof in comparison to virtual machines.

It has further been discovered that the trap function 329 regularly injected into the instruction stream according to the injection interval 331 provides efficient adjustments and corrections. The regular reporting resulting from the trap function 329 regularly injected according to the injection interval 331 can provide a measure for a degree, a severity, a size, a quality, or a combination thereof for the conflicts, errors, sources thereof, or a combination thereof. The regular reporting can be used to balance the cost and the benefit as described above. The results of the regular reporting can be used to trigger adjustments when the benefit of generating the adjusted sets 330 exceed the cost thereof, thereby preserving the overall gain from the process and providing efficiency for the computing system 100.

The adjustment block 304 can use the parallel framework 248, the memory management unit 244, the booting mechanism 238, or a combination thereof to correct the memory sets 246 or content therein as described above. The adjustment block 304 can further use the control unit 112, the control interface 122, the storage unit 114, the storage interface 124, or a combination thereof. The adjustment block 304 can store the processing result, such as the adjusted sets 330 in the control unit 112, the storage unit 114, or a combination thereof.

After generating the adjusted sets 330, the control flow can pass to the balancing block 306. The control flow can be passed similarly as described above between the framework block 302 and the adjustment block 304, but using processing results of the adjustment block 304, such as the adjusted sets 330.

The control flow can also be passed back to the framework block 302. The framework block 302 can use the adjusted sets 330 to provide access for the pages or physical addresses to the operating system 240 as described above.

The balancing block 306 is configured to optimize the computing system 100 for the context associated thereto. The balancing block 306 can optimize for preserving power and prolonging use of the computing system 100. The balancing block 306 can further optimize for maximizing processing speed or capacity. The balancing block 306 can include a condition block 332, a management block 334, or a combination thereof for optimizing the computing system 100.

The condition block 332 is configured to determine the context for the computing system 100. The condition block 332 can determine the context by calculating a current demand 336.

The current demand 336 is a representation of a condition, a resource, a state, or a combination thereof desirable or needed for a current situation or usage of the computing system 100. The current demand 336 can be associated with power consumption 338, processing capacity 340, or a combination thereof currently needed or desirable for the computing system 100, currently projected for need or desirability for the computing system 100, or a combination thereof.

The power consumption 338 can include an amount of energy necessary for operating the computing system 100. The processing capacity 340 can include a quantitative representation of computational cost or demand required for operating the computing system 100.

The processing capacity 340 can include a number of clock cycles, amount of memory, a number of threads, an amount of occupied circuitry, a number of cores, instances of the architectural components 204, a number of pages, or a combination thereof. The power consumption 338, the processing capacity 340, or a combination thereof for operating the computing system 100 can specifically correspond to or be affected by operation or usage of the architectural components 204, current or upcoming processes or instructions, currently operating or scheduled operation of an application, or a combination thereof.

The condition block 332 can calculate the current demand 336 based on various factors. For example, the condition block 332 can calculate the current demand 336 based on the identity of a process, an application, a state or status thereof, a condition or a state associated with the computing system 100, an importance or a priority associated thereto, an identity or a usage amount of the architectural components 204, a consumption profile of a component or an application, or a combination thereof currently applicable to the computing system 100 or the storage unit 114.

Also for example, the condition block 332 can calculate the current demand 336 based on usage patterns, personal preferences, background processes, scheduled processes, projected uses or states, or a combination thereof. As a more specific example, the condition block 332 can collect and use usage records or history, a pattern therein, or a combination thereof to calculate the current demand 336. Also as a more specific example, the condition block 332 can use the calendar or system scheduler at the component level or the operating system level to determine background process, projected use or state, scheduled process, or a combination thereof.

Also for example, the condition block 332 can calculate the current demand 336 based on desired battery life, remaining energy level, or a combination thereof. Also for example, the condition block 332 can calculate the current demand 336 based on a computational intensity or complexity associated with an instruction, a process, an application, or a combination thereof currently in progress or projected for implementation.

The condition block 332 can include a method, a process, a circuit, an equation, or a combination thereof for utilizing the various contextual parameters discussed above to calculate the current demand 336. The condition block 332 can calculate the current demand 336 for representing the power consumption 338, the processing capacity 340, or a combination thereof currently required or demanded.

The management block 334 is configured to adjust the operation of the computing system 100 according to the context. The management block 334 can adjust the operation based on controlling the usage or availability of the architectural components 204 through the memory sets 246 or the adjusted sets 330. The management block 334 can adjust the operation based on the current demand 336 for representing the context associated with the power consumption 338, the processing capacity 340, or a combination thereof.

The management block 334 can adjust the operation of the computing system 100 by generating or adjusting usable resource profile 342. The usable resource profile 342 is a representation of the control or the availability of the architectural components 204 for addressing the context of the computing system 100. The usable resource profile 342 can correspond to enabling or disabling access or usage of the architectural components 204 or other components.

The usable resource profile 342 can include a control or a limitation for enabling access to the pages or instances in the memory sets 246 or the adjusted sets 330. Since the memory sets 246 and the adjusted sets 330 can mirror the architectural components 204 or the parallel structure 216 thereof, controlling or limiting access to the memory sets 246 and the adjusted sets 330 can control the access to or usage of the architectural components 204.

The management block 334 can generate or adjust the usable resource profile 342 based on the current demand 336 for controlling the architectural components 204. The management block 334 can generate or adjust the usable resource profile 342 based on the current demand 336 to optimize or balance the processing capacity 340, the power consumption 338, or a combination thereof.

The management block 334 can determine the amount of resources necessary to meet the power consumption 338, the processing capacity 340, or a combination thereof represented by the current demand 336. For example, the management block 334 can generate or adjust the usable resource profile 342 to disable portions of the architectural components 204 to optimize or reduce the power consumption 338 according to the current demand 336 or context. The optimization or reduction for the power consumption 338 can result in reduction of the processing capacity 340.

Also for example, the management block 334 can generate or adjust the usable resource profile 342 to enable portions of the architectural components 204 to optimize or increase the processing capacity 340 according to the current demand 336 or context. The optimization or increase in the processing capacity 340 can result in increase for the power consumption 338.

The management block 334 can generate or adjust the usable resource profile 342 by determining a performance or a consumption associated with the architectural components 204. The management block 334 can enable or disable one or more instances of the architectural components 204 to match the current demand 336 in generating or adjusting the usable resource profile 342.

The management block 334 can further balance the power consumption 338 and the processing capacity 340 for the current demand 336. The management block 334 can balance based on combining the power consumption 338 and the processing capacity 340 for the current demand 336. The management block 334 can include a process, a method, an equation, circuitry, or a combination thereof predetermined by the computing system 100 for balancing the power consumption 338 and the processing capacity 340.

For example, the management block 334 can average the amount of resources, such as corresponding to the architectural components 204, corresponding to interests of the power consumption 338 and the processing capacity 340. Also for example, the management block 334 can further use weights corresponding to priority, urgency, importance, or a combination thereof for the processes, instructions, applications, or a combination thereof generating or tied to the power consumption 338 or the processing capacity 340.

Also for example, the management block 334 can generate or adjust the usable resource profile 342 by generating the adjusted sets 330. As a more specific example, the management block 334 can migrate pages to include the necessary or often-used pages in a limited number of the architectural components 204, such as the banks or the chips. The management block 334 can balance the cost and the benefit of such migration, similar to the remapping block 324 described above. The management block 334 can further remap similar to the remapping block 324 described above based on the comparison of the cost and benefit.

It has been discovered that the usable resource profile 342 dynamically generated based on the context provides lower overall power consumption without decreasing the performance of the computing system 100. Main memory can contribute substantially to the overall processor or system on chip (SoC) power. The power consumption can grow even greater with increases in memory channel numbers. When active power consumption is desired over performance, the usable resource profile 342 can be used to tune the framework to allocate pages to support a minimum number of active memory channels and still meet performance requirements. The usable resource profile 342 can allow non-allocated memory channels to transition to low power states, effectively reducing active system power. When performance bursts are required, updated framework policies resulting from the usable resource profile 342 can assign memory from inactive memory channels.

It has been discovered that the usable resource profile 342 dynamically generated using the current demand 336 corresponding to the power consumption 338 and the processing capacity 340 provides increased processing efficiency. The usable resource profile 342 can dynamically balance the power consumption 338 and the processing capacity 340 during the active state 314 specific to the architectural components 204 and the parallel structure 216 thereof through the memory sets 246 or the adjusted sets 330.

The usable resource profile 342 can provide a continuum for balancing various levels or combinations of the power consumption 338 and the processing capacity 340 instead of a binary mode. The continuum utilizing the resources at the lowest instance of the granularity level 242 can provide customized set of the architectural components 204 necessary for meeting the balance between the power consumption 338 and the processing capacity 340 instead of a predetermined set of components corresponding to a predetermined mode.

The balancing block 306 can use the parallel framework 248, the memory management unit 244, the booting mechanism 238, or a combination thereof to optimize the computing system 100 based on the context as described above. The balancing block 306 can further use the control unit 112, the control interface 122, the storage unit 114, the storage interface 124, or a combination thereof. The balancing block 306 can store the processing result, such as the usable resource profile 342 in the control unit 112, the storage unit 114, or a combination thereof.

After optimization, the control flow can pass to the framework block 302. The control flow can be passed similarly as described above between the framework block 302 and the adjustment block 304, but using processing results of the balancing block 306, such as the usable resource profile 342.

The framework block 302 can use the usable resource profile 342 to control and operate the computing system 100, the device 102, the architectural components 204, or a combination therein. The framework block 302 can provide access for the pages or physical addresses to the operating system 240 as described above with designated instance or amount of architectural components 204 as according to the pages in the usable resource profile 342.

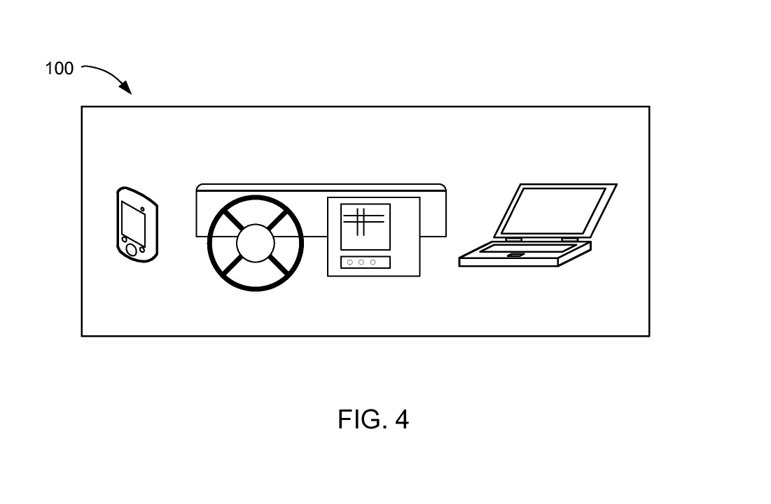

Referring now to FIG. 4, therein is shown examples of the computing system 100 as application examples with the embodiment of the present invention. FIG. 4 depicts various embodiments, as examples, for the computing system 100, such as a smart phone, a dash board of an automobile, and a notebook computer, as example examples with embodiments of the present invention. These application examples illustrate the importance of the various embodiments of the present invention to provide improved processing performance while minimizing power consumption utilizing the memory sets 246 of FIG. 2, the adjusted sets 330 of FIG. 3, the usable resource profile 342 of FIG. 3, or a combination thereof.

In an example where an embodiment of the present invention is an integrated circuit processor or a SoC the blocks described above are embedded therein, various embodiments of the present invention can reduce overall time, power, or a combination thereof required for accessing instructions or data while reducing penalties from misses for improved performance of the processor.

The computing system 100, such as the smart phone, the dash board, and the notebook computer, can include a one or more of a subsystem (not shown), such as a printed circuit board having various embodiments of the present invention or an electronic assembly having various embodiments of the present invention. The computing system 100 can also be implemented as an adapter card.

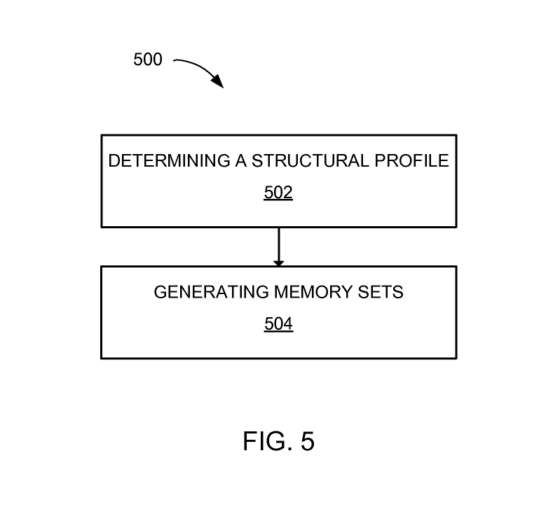

Referring now to FIG. 5, therein is shown a flow chart of a method 500 of operation of a computing system 100 in an embodiment of the present invention. The method 500 includes: determining a structural profile for representing a parallel structure of architectural components in a process 502; and generating memory sets with a control unit based on the structural profile for representing the parallel structure in a process 504.

The method 500 can further include the process 502 determining the structural profile based on a granularity level accessible to the identification block. The method 500 can further include process 504 generating the memory sets including generating the memory sets based on a lowest instance of the granularity level. The method 500 can further include dynamically generating one or more adjusted sets for replacing one or more of the memory sets or a portion therein in response to, such as alternate or additional input into process 504, an irregular status associated with the one or more of the memory sets, adjusting a usable resource profile based on a current demand for controlling one or more of the architectural components, generating a qualified available set according to a non-linear access mechanism for representing one or more of the memory sets reflecting the parallel structure, or a combination thereof relative to the process 502, the process 504, or a combination thereof, such as within, before, after, or in between the two processes.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A computing system comprising:
an identification block configured to determine a structural profile for representing a parallel structure of architectural components; and
an arrangement block, coupled to the identification block, configured to generate memory sets based on the structural profile for representing the parallel structure.

2. The system as claimed in claim 1 wherein:
the identification block is configured to determine the structural profile based on a granularity level accessible to the identification block; and
the arrangement block is configured to generate the memory sets based on lowest instance of the granularity level.

3. The system as claimed in claim 1 further comprising an adjustment block configured to dynamically generate one or more adjusted sets for replacing one or more of the memory sets or a portion therein in response to an irregular status associated with the one or more of the memory sets.

4. The system as claimed in claim 1 further comprising a balancing block configured to adjust a usable resource profile based on a current demand for controlling one or more of the architectural components.

5. The system as claimed in claim 1 wherein the identification block is configured to generate qualified available sets according to a non-linear access mechanism for representing one or more of the memory sets reflecting the parallel structure.

6. The system as claimed in claim 1 wherein:
the identification block is configured to determine the structural profile for representing the parallel structure of the architectural components in a storage unit;
the arrangement block is configured to:
generate the memory sets based on the structural profile for representing the parallel structure for booting mechanism, and
dynamically adjust the memory sets for representing the parallel structure during active state of operating system.

7. The system as claimed in claim 6 wherein the arrangement block is configured to generate a first page and a second page for matching the parallel structure of a first bank component and a second bank component.

8. The system as claimed in claim 6 further comprising:
a status block, coupled to the arrangement block, configured to detect an irregular status during an active state for accessing one or more of the memory sets;
a source block, coupled to the status block, configured to identify a conflict source in the one or more of the memory sets associated with the irregular status during the active state; and
a remapping block, coupled to the source block, configured to dynamically generate adjusted sets based on the conflict source for replacing the memory sets or a portion therein associated with the conflict source during operation of an operating system in response to the irregular status.

9. The system as claimed in claim 6 further comprising:
a condition block, coupled to the arrangement block, configured to calculate a current demand associated with processing capacity; and
a management block, coupled to the condition block, configured to adjust a usable resource profile based on the current demand for controlling the architectural components to optimize the processing capacity.

10. The system as claimed in claim 6 further comprising:
a condition block, coupled to the arrangement block, configured to calculate a current demand associated with power consumption; and
a management block, coupled to the condition block, configured to adjust a usable resource profile based on the current demand for controlling the architectural components to optimize the power consumption.

11. A method of operation of a computing system comprising:
determining a structural profile for representing a parallel structure of architectural components; and
generating memory sets with a control unit based on the structural profile for representing the parallel structure.

12. The method as claimed in claim 11 wherein:
determining the structural profile includes determining the structural profile based on a granularity level accessible to the identification block; and
generating the memory sets includes generating the memory sets based on lowest instance of the granularity level.

13. The method as claimed in claim 11 further comprising dynamically generating one or more adjusted sets for replacing one or more of the memory sets or a portion therein in response to an irregular status associated with the one or more of the memory sets.

14. The method as claimed in claim 11 further comprising adjusting a usable resource profile based on a current demand for controlling one or more of the architectural components.

15. The method as claimed in claim 11 further comprising generating qualified available sets according to a non-linear access mechanism for representing one or more of the memory sets reflecting the parallel structure.

16. A non-transitory computer readable medium including instructions for a computing system comprising:
determining a structural profile for representing a parallel structure of architectural components; and
generating memory sets based on the structural profile for representing the parallel structure.

17. The non-transitory computer readable medium as claimed in claim 16 wherein:
determining the structural profile includes determining the structural profile based on a granularity level accessible to the identification block; and
generating the memory sets includes generating the memory sets based on lowest instance of the granularity level.

18. The non-transitory computer readable medium as claimed in claim 16 further comprising dynamically generating one or more adjusted sets for replacing one or more of the memory sets or a portion therein in response to an irregular status associated with the one or more of the memory sets.

19. The non-transitory computer readable medium as claimed in claim 16 further comprising adjusting a usable resource profile based on a current demand for controlling one or more of the architectural components.

20. The non-transitory computer readable medium as claimed in claim 16 further comprising further comprising generating qualified available sets according to a non-linear access mechanism for representing one or more of the memory sets reflecting the parallel structure.
